(19) United States
(12) Patent Application Publication
(10) Pub. No.: US 2016/0164063 A1
(43) Pub. Date: Jun. 9, 2016

(54) ELECTRIC CELL CONNECTOR FOR A BATTERY MODULE

(71) Applicant: ROBERT BOSCH GMBH, Stuttgart (DE)

(72) Inventors: Ralf ANGERBAUER, Moeglingen (DE); Andreas RUEHLE, Bietigheim-Bissingen (DE)

(21) Appl. No.: 14/903,787

(22) PCT Filed: Jun. 24, 2014
(86) PCT No.: PCT/EP2014/063204

§ 371 Date: Jan. 19, 2016

(30) Foreign Application Priority Data
Jul. 10, 2013 (DE) 10 2013 213 527.0

(51) Int. Cl. H01M 2/20; H01M 10/0525

(52) U.S. Cl. CPC H01M 2/206; H01M 10/0525; H01M 2220/20

(57) ABSTRACT

The invention relates to a battery module having at least two battery cells, the at least two battery cells comprising electric cell contacts. Said cell contacts are interconnected in a conductive manner by means of at least one cell connector which comprises a bonding wire and/or a bonding strip.

### BACKGROUND OF THE INVENTION

The invention is based on an electric cell connector for a battery module.

Cell connectors which connect at least two battery cells of a battery module in an electrically conducting manner are known from the prior art. For this purpose, for example thin, layered or corrugated-shaped pieces of sheet metal are used.

### SUMMARY OF THE INVENTION

A disadvantage with the known prior art is that various manufacturing steps are necessary for the manufacture and mounting of a cell connector. The electric cell connector is therefore fabricated from one piece or is assembly from a plurality of electrically conductive materials, wherein for the electrical and mechanical connection, for example a cutout is punched with a high degree of measurement accuracy into the cell connector. In order to compensate tolerances of the battery cells and the intrinsic movements of the cells, the electric cell connector is additionally bent at at least one point. The electric cell connector is subsequently welded, bonded or clamped to the battery cells.

The procedure according to the invention has, in contrast, the advantage that in order to establish an electrically conductive connection between at least two battery cells a cell connector comprises at least one bonding wire and/or one bonding strip.

Aluminum or aluminum-silicon or copper or gold is advantageously used as the material for the bonding wire and/or the bonding strip in order to reduce line losses.

The bonding wire advantageously has a diameter between 200 μm and 600 μm as a function of a specific energy density, for example 200 Wh/kg and a number of battery cells of the respective battery module, with the result that a maximum flow of current of, for example, 20 A through the bonding wire is ensured, without the bonding wire being, for example, damaged by the action of heat.

The bonding strip advantageously has a rectangular cross section with a width between 150 μm and 5000 μm and a height between 100 μm and 500 μm as a function of a specific energy density, for example 240 Wh/kg and a number of battery cells of the respective battery module, with the result that a maximum flow of current of, for example, 80 A through the bonding strip is ensured, without the bonding strip being damaged, for example, by the action of heating.

When a bonding strip is used there is advantageously less damage to contact-forming faces, such as for example, fracture points on contact-forming faces as a result of excessive bending of the bonding wire. As a result it is possible to bridge the same distance with a bonding strip which is shorter compared to a bonding wire.

When there is an electrically conductive connection which comprises more than one bonding wire and/or more than one bonding strip as the cell connector, contact-forming faces of the bonding wires and/or of the bonding strips are advantageously arranged one next to the other on a cell contact and/or one on top of the other on the cell contact of the battery cell.

In order to establish an electrically conductive connection between the bonding wire and/or the bonding strip and a cell contact of the battery cell, different method variants such as thermocompression bonding (TC bonding), thermosonic ball wedge bonding (TS bonding) and/or ultrasonic wedge-wedge bonding (US bonding) are used.

These methods are selected, for example, on the basis of a material used for the bonding wires or the bonding strip. Therefore, TC bonding is used rarely for wire bonding since the large forces and high temperatures which are necessary for the connection can cause damage to the connecting elements, whereas the method is suitable for bonding strips. If gold or copper is used as the material for the bonding wires or bonding strips, TS bonding is suitable. If, on the other hand, aluminum or aluminum-silicon is used as the material for the bonding wires or bonding strips, US bonding is advantageously suitable.

A new geometry and/or new arrangement of battery cells is advantageously possible owing to the mechanical flexibility of the bonding wires and/or of the bonding strips as cell connectors. New geometries can advantageously be implemented by using the bonding wires and/or the bonding strips with less expenditure on changing bonding machines.

Because less material is required, each individual cell connector results in a saving in weight, which increases, for example, a range of a vehicle.

A repair of defective electrical connections between cell contacts is advantageously possible at comparatively low cost in a comparison between a use of bonding wires and/or bonding strips and a use of cell connectors according to the prior art. In order to repair a defective electrical connection, at least one new bonding wire and/or a new bonding strip is placed in electrical contact with the cell contacts by means of bonding, wherein sufficient contact-forming faces are advantageously present on the cell contacts by virtue of small cross sections of the bonding wires and/or bonding strips.

As a result of the formation of contact with redundant bonding wires and/or bonding strips, for example by means of at least one further bonding strip between two cell contacts which is not necessary to ensure a sufficiently high flow of current, the probability of the failure of the respective battery module is advantageously reduced.

Few manufacturing steps for making contact with battery cells by means of bonding wires and/or bonding strips as cell connectors are advantageously necessary, as a result of which low technical expenditure for a manufacturing process of battery modules is necessary and a relatively high degree of automation is made possible.

The battery module is advantageously used in a lithium-ion battery.

### BRIEF DESCRIPTION OF THE DRAWINGS

The exemplary embodiments of the invention are illustrated in the drawing and explained in more detail in the following description.

In the drawing:

FIG. 1 shows an embodiment according to the prior art; and

FIG. 2 shows an embodiment of the device according to the invention.

### DETAILED DESCRIPTION

Identical reference symbols denote identical device components in all the figures.

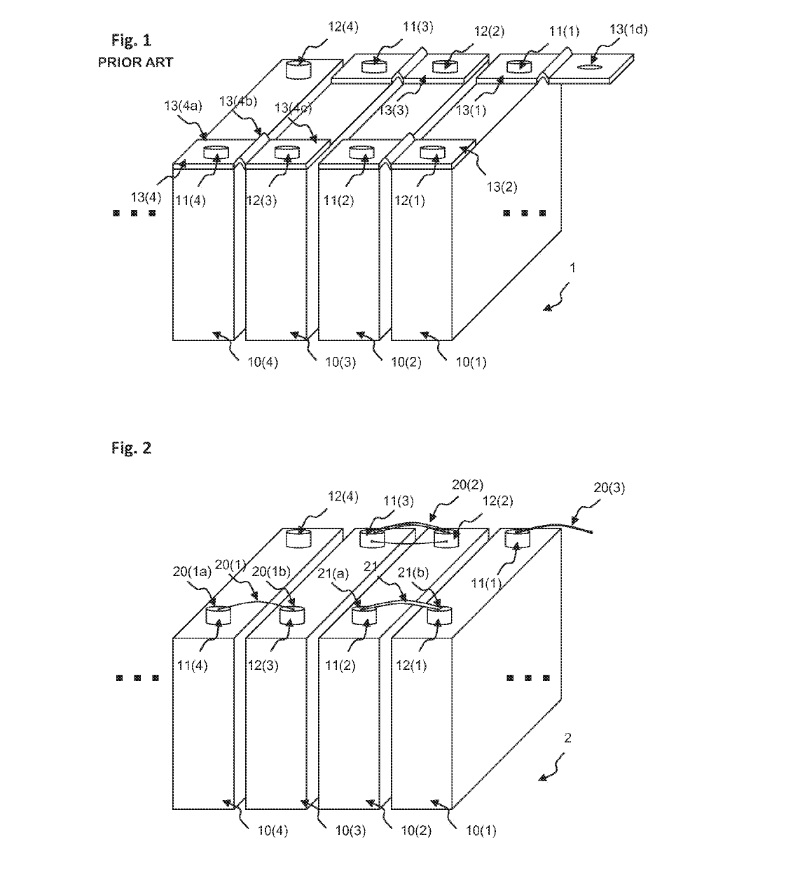

FIG. 1 shows four battery cells 10(1), 10(2), 10(3), 10(4) of a battery module 1 with cell contacts 11(1), 11(2), 11(3), 11(4), 12(1), 12(2), 12(3), 12(4) which are connected to one another in an electrically conductive manner via electric cell connectors 13(1), 13(2), 13(3), 13(4) resulting in a series connection of the battery cells 10(1), 10(2), 10(3), 10(4), according to an embodiment in accordance with the prior art. For example, the positive pole of the battery cell 10(1) is connected by means of the cell contact 12(1) via the electric cell connector 13(2) to the negative pole of the battery cell 10(2) by means of the cell contact 11(2).

The electric cell connector 13(4) comprises a first connecting element 13(4a), a second connecting element 13(4c) and a bent connecting element 13(4b) which electrically contacts the first connecting element 13(4a) to the second connecting element 13(4c). In order to establish an electrically conductive connection and mechanical connection between the cell contact 11(1) and a cell contact of a further battery cell by means of the cell connector 13(1), the cell connector 13(1) has, for example, a cutout 13(1d).

The electric cell connector 13(4) can be fabricated from one piece or be assembled from different electrically conductive materials. Tolerance of the battery cells and intrinsic movements of the cells are compensated by the bent connecting element 13(4b).

The electric cell connector 13(4) is welded or bonded or clamped to the battery cells 10(3), 10(4).

FIG. 2 shows four battery cells 10(1), 10(2), 10(3), 10(4) of a battery module 2 according to an embodiment of the invention with cell contacts 11(1), 11(2), 11(3), 11(4), 12(1), 12(2), 12(3), 12(4) which are connected to one another in an electrically conductive fashion via electric cell connectors 20(1), 20(2), 20(3), 21, resulting in a series connection of the battery cells 10(1), 10(2), 10(3), 10(4).

In one advantageous embodiment, the electric cell connector 20(1) comprises an individual bonding wire with a first contact-forming face 20(1a) on a first cell contact 11(4) and a second contact-forming face 20(1b) on a second cell contact 12(3).

In one alternative embodiment, the electric cell connector 20(2) comprises at least two bonding wires.

In a further alternative embodiment, the electric cell connector 21 comprises a bonding strip with a first contact-forming face 21(a) on a first cell contact 11(2), and a second contact-forming face 21(b) on a second cell contact 12(1).

An electrically conductive connection between the cell contact 11(1) and a cell contact of a further battery cell is established by means of the cell connector 20(3).

Aluminum, aluminum-silicon, copper or gold is used as the material for the at least one bonding wire and the at least one bonding strip.

The diameter of the bonding wire is advantageously between 500 μm and 600 μm, with the result that a maximum flow of current of 20 A through the bonding wire is ensured without the bonding wire being damaged, for example, by the action of heat.

In a first advantageous embodiment, the width of the bonding strip is 2000 μm and the height of the bonding strip 200 μm, and as a result two bonding wires with a diameter of 500 μm can be replaced by one bonding strip.

In a second advantageous embodiment, the width of the bonding strip is 4000 μm and the height of the bonding wire 200 μm, and as a result four bonding wires with a diameter of 500 μm can be replaced by one bonding strip.

In a third advantageous embodiment, the width of the bonding strip is 5000 μm and the height of the bonding strip 300 μm, and as a result seven bonding wires with a diameter of 500 μm can be replaced by one bonding strip.

The length of the bonding wire and/or of the bonding strip is advantageously between 10 mm and 50 mm, in order to ensure sufficient mechanical stability between two contact-forming faces 20(1a), 20(1b) and respectively 21(a), 21(b).

1. A battery module (2) having at least two battery cells (10(1), 10(2), 10(3), 10(4)), wherein the at least two battery cells (10(1), 10(2), 10(3), 10(4)) comprise electric cell contacts (11(1), 11(2), 11(3), 11(4), 12(1), 12(2), 12(3), 12(4)), wherein pairs of the cell contacts are connected to one another in a conductive manner by respective cell connectors (20(1), 20(2), 20(3), 20(4)), characterized in that each of the cell connectors comprises a bonding wire and/or a bonding strip.

2. The battery module (2) as claimed in claim 1, characterized in that aluminum or aluminum-silicon or copper or gold is used as the material for the bonding wire and/or the bonding strip.

3. The battery module (2) as claimed in claim 1, characterized in that the bonding wire has a diameter between 200 μm and 600 μm.

4. The battery module (2) as claimed in claim 1, characterized in that the bonding strip has a rectangular cross section with a height between 100 μm and 500 μm.

5. The battery module (2) as claimed in claim 4, characterized in that the bonding strip has a width between 150 μm and 2500 μm.

6. The battery module (2) as claimed in claim 4, characterized in that the bonding strip has a width between 2500 μm and 5000 μm.

7. The battery module (2) as claimed in claim 1, characterized in that the bonding wire and/or the bonding strip have/has a length between 10 mm and 50 mm.

8. The battery module (2) as claimed in claim 1, characterized in that in the case of a cell connector (20(2)) which comprises more than one bonding wire and/or more than one bonding strip as the cell connector, contact-forming faces of the bonding wires and/or of the bonding strips are arranged one next to the other on the cell contacts (11(3), 12(2)) and/or one on top of the other on the cell contacts (11(3), 12(2)).

9. A method for establishing an electrically conductive connection between at least two battery cells (10(1), 10(2), 10(3), 10(4)) of a battery module (2) as claimed in claim 1, characterized in that each electrically conductive connection is established by a contact-forming face (20(1a), 20(1b), 21(a), 21(b)) between at least one bonding wire and/or at least one bonding strip and a respective cell contact by thermosonic ball wedge bonding and/or ultrasonic wedge-wedge bonding and/or thermocompression bonding.

10. (canceled)

11. A lithium-ion battery comprising a battery module (2) as claimed in claim 1.

12. A battery module (2) having at least two battery cells (10(1), 10(2), 10(3), 10(4)), wherein the at least two battery cells (10(1), 10(2), 10(3), 10(4)) comprise electric cell contacts (12(1), 11(2) connected to one another in a conductive manner by at least one cell connector (20(1), 20(2), 20(3), 20(4)), wherein the at least one cell connector comprises at least one of a bonding wire and a bonding strip.

13. The battery module (2) as claimed in claim 12, wherein the at least one cell connector comprises a bonding wire.

14. The battery module (2) as claimed in claim 13, wherein the at least one cell connector also comprises a bonding strip.

15. The battery module (2) as claimed in claim 12, wherein the at least one cell connector comprises a bonding strip.

16. The battery module (2) as claimed in claim 12, characterized in that aluminum or aluminum-silicon or copper or gold is used as the material for the bonding wire or bonding strip.

17. The battery module (2) as claimed in claim 13, characterized in that the bonding wire has a diameter between 200 μm and 600 μm.

18. The battery module (2) as claimed in claim 15, characterized in that the bonding strip has a rectangular cross section with a height between 100 μm and 500 μm.

19. The battery module (2) as claimed in claim 18, characterized in that the bonding strip has a width between 150 μm and 2500 μm.

20. The battery module (2) as claimed in claim 18, characterized in that the bonding strip has a width between 2500 μm and 5000 μm.

21. The battery module (2) as claimed in claim 12, characterized in that the bonding wire or bonding strip has a length between 10 mm and 50 mm.
